(19) United States
(12) Patent Application Publication
(10) Pub. No.: US 2017/0086132 A1
(43) Pub. Date: Mar. 23, 2017

(54) CELL DISCOVERY IN A WIRELESS NETWORK USING USER EQUIPMENT (UE) HISTORY INFORMATION

(71) Applicant: QUALCOMM Incorporated, San Diego, CA (US)

(72) Inventors: Damanjit SINGH, San Diego, CA (US); Farhad MESHKATI, San Diego, CA (US)

(21) Appl. No.: 14/861,787

(22) Filed: Sep. 22, 2015

(51) Int. Cl. H04W 48/16; H04W 8/24

(52) U.S. Cl. CPC H04W 48/16; H04W 8/24

(57) ABSTRACT

The present disclosure presents a method and an apparatus for cell discovery in a wireless network. For example, the method may include identifying at a third cell that a first cell is a neighbor of a second cell, wherein the third cell and the second cell are neighbors, and wherein the identifying is based at least on a user equipment (UE) history information information element (IE) of a UE and performing an action at the third cell based at least on information acquired from the identification. As such, a cell may be discovered in a wireless network.

### INTRODUCTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of eNodeBs that can support communication for a number of user equipments (UEs). A UE may communicate with an eNodeB via the downlink and uplink. The downlink (or forward link) refers to the communication link from the eNodeB to the UE, and the uplink (or reverse link) refers to the communication link from the UE to the eNodeB.

In some instances, discovery of neighbors of neighbors cells may be a challenge due to absence of X2 connections between neighbors, for example, discovery of neighbors of neighbors in self organizing networks (SONs). The discovery of neighbors of neighbors may be useful in many scenarios, e.g., physical cell identity (PCI) selection, neighbor list additions, etc.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure presents an example method and apparatus for discovering a cell in a wireless network. For example, in an aspect, the present disclosure presents an example method that may include identifying at a third cell that a first cell is a neighbor of a second cell, wherein the third cell and the second cell are neighbors, and wherein the identifying is based at least on a user equipment (UE) history information information element (IE) of a UE and performing an action at the third cell based at least on information acquired from the identification.

Additionally, the present disclosure presents an example apparatus for discovering a cell in a wireless network that may include means for identifying at a third cell that a first cell is a neighbor of a second cell, wherein the third cell and the second cell are neighbors, and wherein the identifying is based at least on a user equipment (UE) history information information element (IE) of a UE and means for performing an action at the third cell based at least on information acquired from the identification.

In a further aspect, the present disclosure presents an example computer readable medium storing computer executable code for discovering a cell in a wireless network that may include code for identifying at a third cell that a first cell is a neighbor of a second cell, wherein the third cell and the second cell are neighbors, and wherein the identifying is based at least on a user equipment (UE) history information information element (IE) of a UE and code for performing an action at the third cell based at least on information acquired from the identification.

Furthermore, in an aspect, the present disclosure presents an example apparatus for discovering a cell in a wireless network that may include a processor and a memory, the processor and the memory configured to identify at a third cell that a first cell is a neighbor of a second cell, wherein the third cell and the second cell are neighbors, and wherein the identifying is based at least on a user equipment (UE) history information information element (IE) of a UE and perform an action at the third cell based at least on information acquired from the identification.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 is a block diagram conceptually illustrating an example of a wireless communications system, in accordance with an aspect of the present disclosure.

FIG. 2 is a block diagram conceptually illustrating an example of a network architecture, in accordance with an aspect of the present disclosure.

FIG. 3 is a flowchart illustrating a method for discovering a cell in a wireless network, in accordance with an aspect of the present disclosure.

FIG. 4 is a block diagram illustrating aspects of a logical grouping of electrical components as contemplated by the present disclosure.

FIG. 5 is a block diagram illustrating an example of a hardware implementation for an apparatus employing a processing system.

FIG. 6 is a block diagram conceptually illustrating an example hardware implementation for an apparatus employing a processing system configured in accordance with an aspect of the present disclosure.

FIG. 7 is a block diagram illustrating a long term evolution (LTE) network, in accordance with an aspect of the present disclosure.

FIG. 8 is a conceptual diagram illustrating an example of an access network for use with a UE, in accordance with an aspect of the present disclosure.

FIG. 9 is a block diagram conceptually illustrating examples of an eNodeB and a UE configured in accordance with an aspect of the present disclosure.

### DETAILED DESCRIPTION

Aspects of the present disclosure generally relate to self-configuration procedures in wireless communications, and more particularly, self-configuring a physical cell identity (PCI) at a cell upon detecting a PCI confusion at a neighbor cell. PCI confusion may occur when two or more neighbors (e.g., target cells) of a source cell have the same PCI and the source cell cannot identify which target cell to use for a UE handover resulting in handover delays and/or failures.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

A small cell or a small cell base station or access point may refer, but is not limited to, a femtocell, picocell, microcell, or any other cell or base station having a relatively small transmit power or relatively small coverage area as compared to a macro cell or macro base station.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). UMB and cdma2000 are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

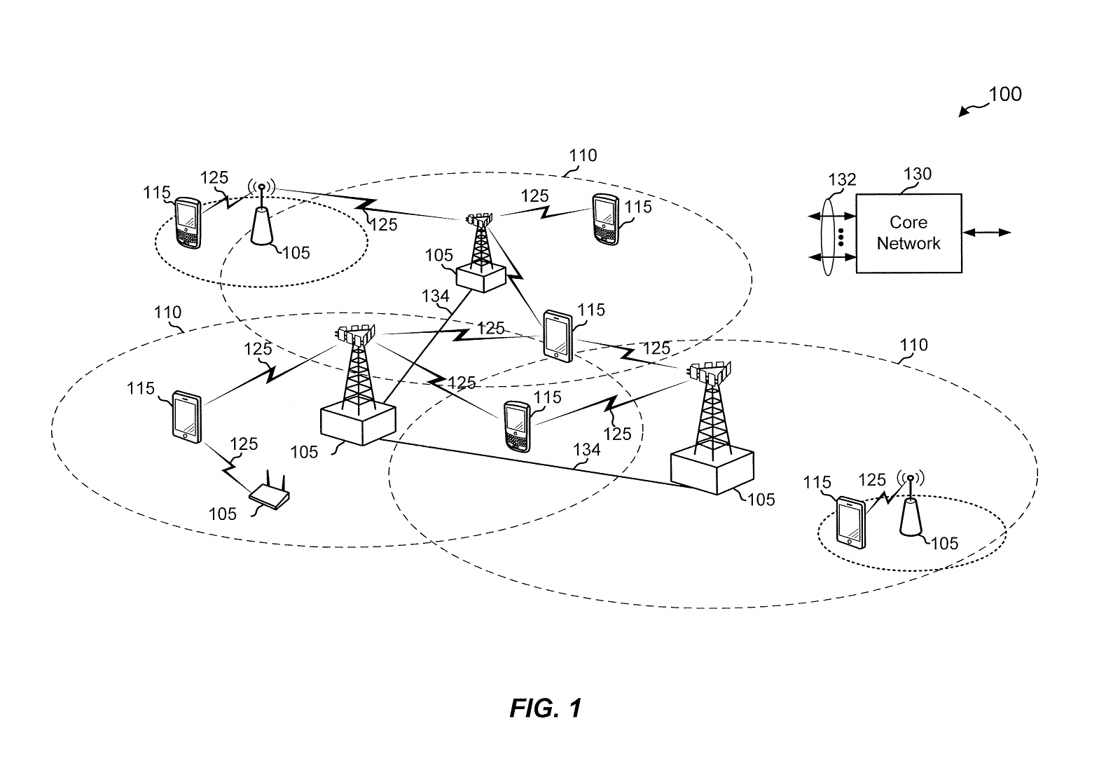

FIG. 1 is a block diagram conceptually illustrating an example of a wireless communications system 100, in accordance with an aspect of the present disclosure. The wireless communications system 100 includes base stations (or cells) 105, user equipment (UEs) 115, and a core network 130. The base stations 105 may communicate with the UEs 115 under the control of a base station controller (not shown), which may be part of the core network 130 or the base stations 105 in various aspects. The base stations 105 may communicate control information and/or user data with the core network 130 through first backhaul links 132. In aspects, the base stations 105 may communicate, either directly or indirectly, with each other over second backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc. The wireless communications system 100 may also support operation on multiple flows at the same time (e.g., cellular and Wi-Fi or wireless local area networks (WLANs)).

The base stations 105 may wirelessly communicate with the UEs 115 via one or more base station antennas. Each of the base stations 105 sites may provide communication coverage for a respective geographic coverage area 110. In some aspects, base stations 105 may be referred to as a base transceiver station, a radio base station, an access point, a radio transceiver, a basic service set (BSS), an extended service set (ESS), a NodeB, eNodeB, Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro, micro, and/or pico base stations). There may be overlapping coverage areas for different technologies.

In an aspect, the wireless communications system 100 is an LTE/LTE-A network communication system. In LTE/LTE-A network communication systems, the terms evolved NodeB (eNodeB) may be generally used to describe the base stations 105. The wireless communications system 100 may be a Heterogeneous LTE/LTE-A network in which different types of eNodeBs provide coverage for various geographical regions. For example, each eNodeB 105 may provide communication coverage for a macro cell, a pico cell, a femtocell, and/or other types of cell. A macro cell generally covers a relatively large geographic area (e.g., several kilometers in radius) and may allow unrestricted access by UEs 115 with service subscriptions with the network provider. A pico cell would generally cover a relatively smaller geographic area (e.g., buildings) and may allow unrestricted access by UEs 115 with service subscriptions with the network provider. A femtocell would also generally cover a relatively small geographic area (e.g., a home) and, in addition to unrestricted access, may also provide restricted access by UEs 115 having an association with the femtocell (e.g., UEs 115 in a closed subscriber group (CSG), UEs 115 for users in the home, and the like). An eNodeB 105 for a macro cell may be referred to as a macro eNodeB. An eNodeB 105 for a pico cell may be referred to as a pico eNodeB. And, an eNodeB 105 for a femtocell may be referred to as a femto eNodeB or a home eNodeB. An eNodeB 105 may support one or multiple (e.g., two, three, four, and the like) cells. The wireless communications system 100 may support use of LTE and WLAN or Wi-Fi by one or more of the UEs 115. A small cell may refer to a micro cell, a pico cell, or a femtocell, for example.

The core network 130 may communicate with the eNodeBs 105 or other base stations 105 via first backhaul links 132 (e.g., S1 interface, etc.). The eNodeBs 105 may also communicate with one another, e.g., directly or indirectly via second backhaul links 134 (e.g., X2 interface, etc.) and/or via the first backhaul links 132 (e.g., through core network 130). The wireless communications system 100 may support synchronous or asynchronous operation. For synchronous operation, the eNodeBs 105 may have similar frame timing, and transmissions from different eNodeBs 105 may be approximately aligned in time. For asynchronous operation, the eNodeBs 105 may have different frame timing, and transmissions from different eNodeBs 105 may not be aligned in time. The techniques described herein may be used for either synchronous or asynchronous operations.

The UEs 115 may be dispersed throughout the wireless communications system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, a wireless network appliance (e.g., devices for Internet of Things (IoT)), or the like. A UE 115 may be able to communicate with macro eNodeBs, pico eNodeBs, femto eNodeBs, relays, and the like.

The communication links 125 shown in the wireless communications system 100 may include uplink (UL) transmissions from a UE 115 to an eNodeB 105, and/or downlink (DL) transmissions, from an eNodeB 105 to a UE 115. The downlink transmissions may also be called forward link transmissions while the uplink transmissions may also be called reverse link transmissions.

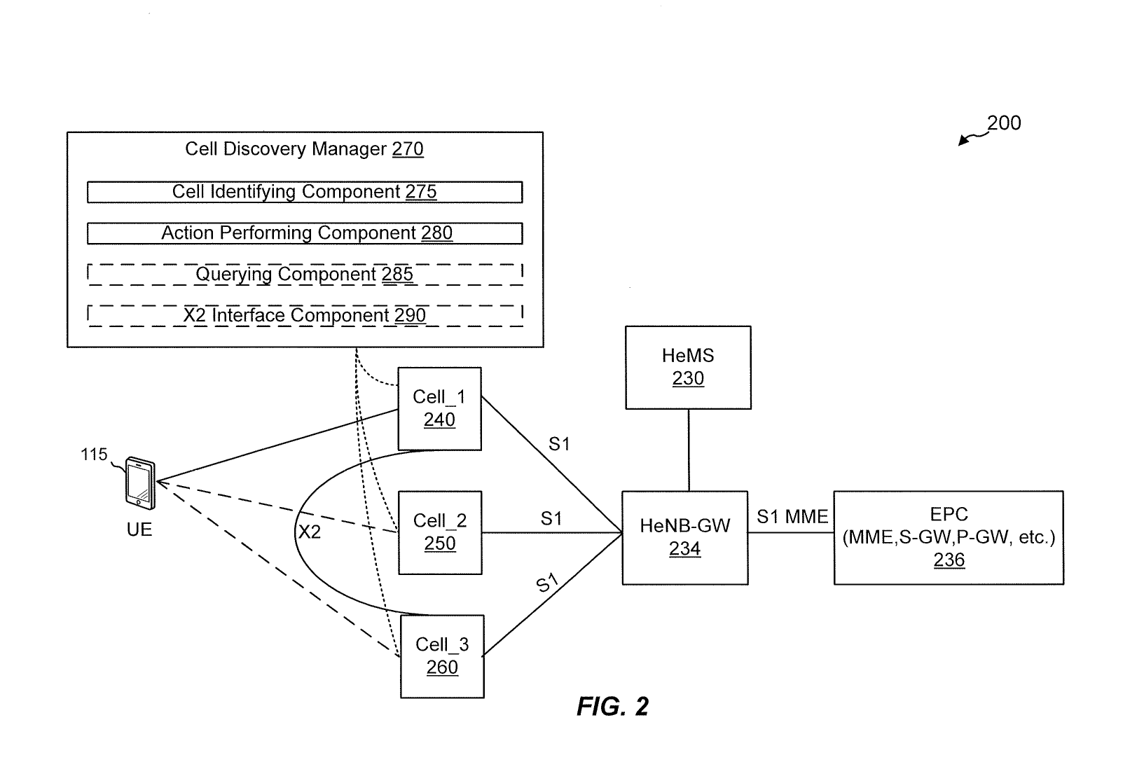

FIG. 2 is a block diagram conceptually illustrating an example of a network architecture 200, in accordance with an aspect of the present disclosure. The network architecture 200 may be part of the wireless communications system 100 of FIG. 1, and may include a home eNodeB management system (HeMS) 230 capable of handling operation, administration, and management (OAM) of small cell base stations in a home network. The network architecture 200 may also include a home eNodeB gateway (HeNB-GW) 234, an evolved packet core (EPC) 236, cell 240 (cell_1 which may be configured with a PCI value of PCI_1), cell 250 (cell_2 which may be configured with a PCI value of PCI_2), and cell 260 (cell_3) is a new cell being added. The cells are in communication with the HeNB-GW 234 via S1/TR069 interfaces. In an additional or an optional aspect, the cells may communicate directly with EPC 236 via S1 interface. UE 115 is in communication with one or more of cells 240, 250, and 260. The HeNB-GW 234 and the EPC 236 may communicate via an S1 mobility management entity (MME) interface. The cells of FIG. 2 may correspond to some of the cells/base stations described above with respect to FIG. 1.

For example, in an aspect, a cell (e.g., cell_3 260 of FIG. 1) that is being added may identify that cell_1 240 is a neighbor of cell_2 250, wherein cell_2 250 is also a neighbor of cell_3 260. Cell_3 260 may identify the neighbor relationships based on, e.g., UE history information information element (IE) received from a UE in communication with cell_3 260. Based on the information received in the UE history information IE, cell_3 260 may detect that a PCI confusion exists at cell_2 250 (i.e., cell_1 240 and cell_3 260 are configured with same PCI values) and may perform an action at cell_3 260. For example, the action performed at cell_3 260 may include changing a PCI, a frequency, a transmitted (TX) power, or any combination thereof, of the cell_3 260.

In an aspect, cell_3 260 may include a cell discovery manager 270 for discovering a cell in a wireless network. The cell discovery manager 270 may include a cell identifying component 275 and an action performing component 280. In an additional or optional aspect, cell discovery manager 270 may optionally include a querying component 285 and/or a X2 interface component 290.

The cell identifying component 275 may include hardware, software, or a combination of hardware and software and may be configured or be operable to identify at a third cell that a first cell is a neighbor of a second cell, wherein the third cell and the second cell are neighbors, and wherein the identifying is based at least on a user equipment (UE) history information information element (IE) of a UE.

The action performing component 280 may include hardware, software, or a combination of hardware and software and may be configured or operable to perform an action at the third cell based at least on information acquired from the identification.

The querying component 285 may include hardware, software, or a combination of hardware and software and may be configured or operable to query a PCI, a frequency, a TX power, or any combination thereof, of the first cell, and/or query a PCI, a frequency, a transmitted (TX) power, or any combination thereof, of the first cell from the network entity.

The X2 interface component 290 may include hardware, software, or a combination of hardware and software and may be configured or operable to establish a X2 interface between the third cell and the first cell.

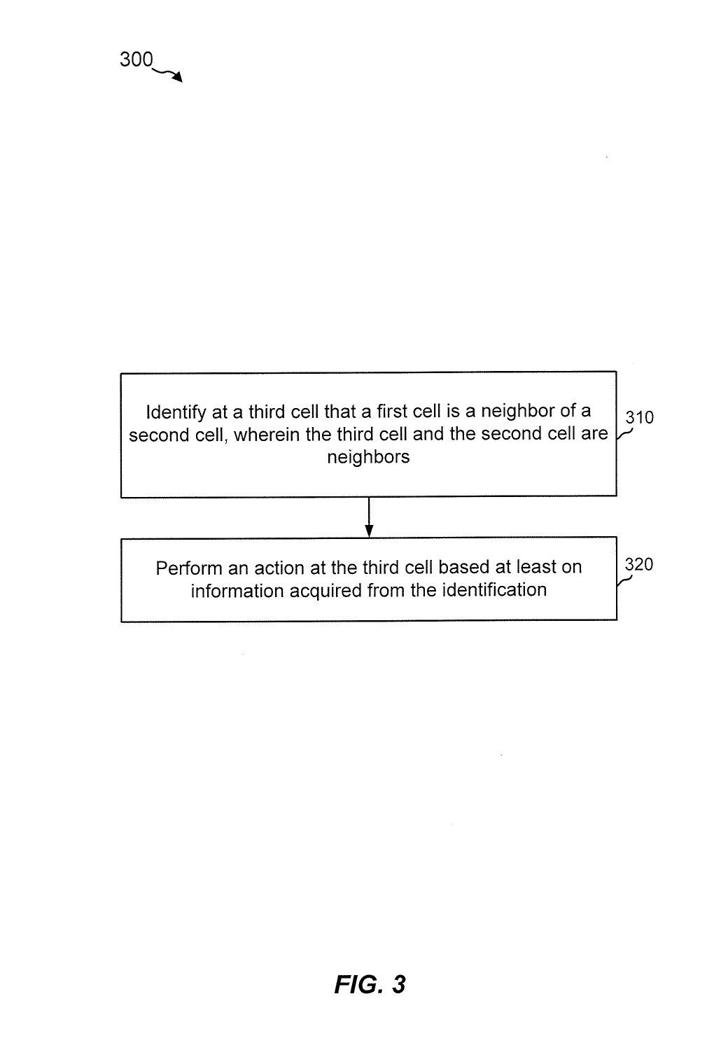

FIG. 3 is a flowchart illustrating a method 300 for discovering a cell in a wireless network. In an aspect, at block 310, methodology 300 may include identifying at a third cell that a first cell is a neighbor of a second cell, wherein the third cell and the second cell are neighbors, and wherein the identifying is based at least on a user equipment (UE) history information information element (IE) of a UE. For example, in an aspect cell_3 260 and/or cell discovery manager 270 may include a specially programmed processor module, or a processor executing specially programmed code stored in a memory, to identify at a third cell (e.g., cell_3 260) that a first cell (e.g., cell_1 240) is a neighbor of a second cell (e.g., cell-2 250), wherein the third cell (e.g., cell_3 260) and the second cell (e.g., cell_2 250) are neighbors, and wherein the identifying is based at least on a user equipment (UE) history information IE of a UE (e.g., UE 115).

In an aspect, for instance, UE history information IE contains information about cells that a UE (e.g., UE 115) has been served by in active state prior to the target cell. The UE history information IE is passed from one cell (e.g., source cell) to another cell (e.g., target cell) during a handover and contains past cell identifies and the time the UE stayed on each cell. For example, in an aspect, UE 115 may be in active state and may be served by cell_1 240, initially handed over to cell_2 250, and later handed over to cell_3 260. In such an instance, for example, UE history information IE of UE 115 may include information of cell_2 250 and cell_1 240 (in that order) and the respective times UE 115 stayed on cell_2 250 and cell_1 240 before being handed over to cell_3 260. Moreover, the information of cell_2 250 and cell_1 240 is in an order with the most recent cell (e.g., cell_2 250) at the top of the order.

In an additional or optional aspect, UE history information IE may be sent from one cell (e.g., cell_1 240) to another cell (cell_2 25) over S1 interface. This allows the transfer of UE history information IE between cells even if X2 interface is not present between cells (e.g., X2 interfaces are not present between cell_2 250 and cell_1 240 and/or cell_2 250 and cell_3 260). The X2 interfaces may not be present due to various reasons. For example, cell_2 250 may not support X2 interface, cell_2 250 may belong to another vendor and inter-vendor X2 is not supported (or not working properly).

In an aspect, at block 320, methodology 300 may include performing an action at the third cell based at least on information acquired from the identification. For example, in an aspect cell_3 260 and/or cell discovery manager 270 may include a specially programmed processor module, or a processor executing specially programmed code stored in a memory, to perform an action at the third cell (e.g., cell_3 260) based at least on information acquired from the identification.

In an aspect, cell_3 260 and/or cell discovery manager 270 may change (e.g., modify, update, etc.) PCI, frequency, or transmitted (TX) power of the cell (e.g., cell_3 260) based at least on the information acquired (e.g., obtained, received, etc.) from the identification (e.g., the information acquired may include PCI, frequency, or TX power of cell_1 240). For example, in an aspect, cell_3 260 and/or cell discovery manager 270 may change PCI, frequency, or TX power of the cell (e.g., cell_3 260) if cell_3 260 determines there is PCI confusion (e.g., same PCI values for neighbors of neighbors) with cell_1 240. For instance, if cell_3 260 determines that PCI configured at cell_3 260 is same as PCI of cell_1 240, cell_3 260 may perform an action (e.g., action to reconfigure, modify, update or revise) to change PCI of cell_3 260. In an additional or optional aspect, cell_3 260 and/or cell discovery manager 270 may change a combination (e.g., any combination) of PCI, frequency, or TX power of the cell_3 260 based at least on the information acquired from the identification.

In an additional aspect, for example, cell_3 260 and/or cell discovery manager 270 may perform an action that may include establishing (e.g., setting up, configuring, etc.) an X2 interface between the third cell (cell_3 260) and the first cell (cell_1 240). That is, an X2 connection is established with the discovered “neighbor or neighbor.” The establishment of the X2 connection between cell_3 260 and cell_1 240 allows cell_3 260 to gather (e.g., retrieve, find out, etc.) more information (e.g., PCI, frequency, TX power) of cell_1 240.

In a further additional aspect, for example, cell_3 260 and/or cell discovery manager 270 may query a network entity (e.g., HeMS 230) for more information about discovered “neighbor of neighbor” (e.g., cell_1 240). In such an aspect, cell_3 260 and/or cell discovery manager 270 may query network entity (e.g., HeMS 230) using identity of cell_1 240, e.g., cell identifier or eCGI.

Additionally, in an aspect, cell_3 260 and/or cell discovery manager 270 may change PCI, frequency, or TX power of the cell (e.g., cell_3 260) based at least on the information received in the UE history information IE. For example, if UE history information IE includes information such as PCI, frequency, TX power, etc., cell_3 260 and/or cell discovery manager 270 may change PCI, frequency, TX power of cell_3 260 based on the information received in the UE history information IE without the need for retrieving such information from cell_1 240 and/or network entity as described above.

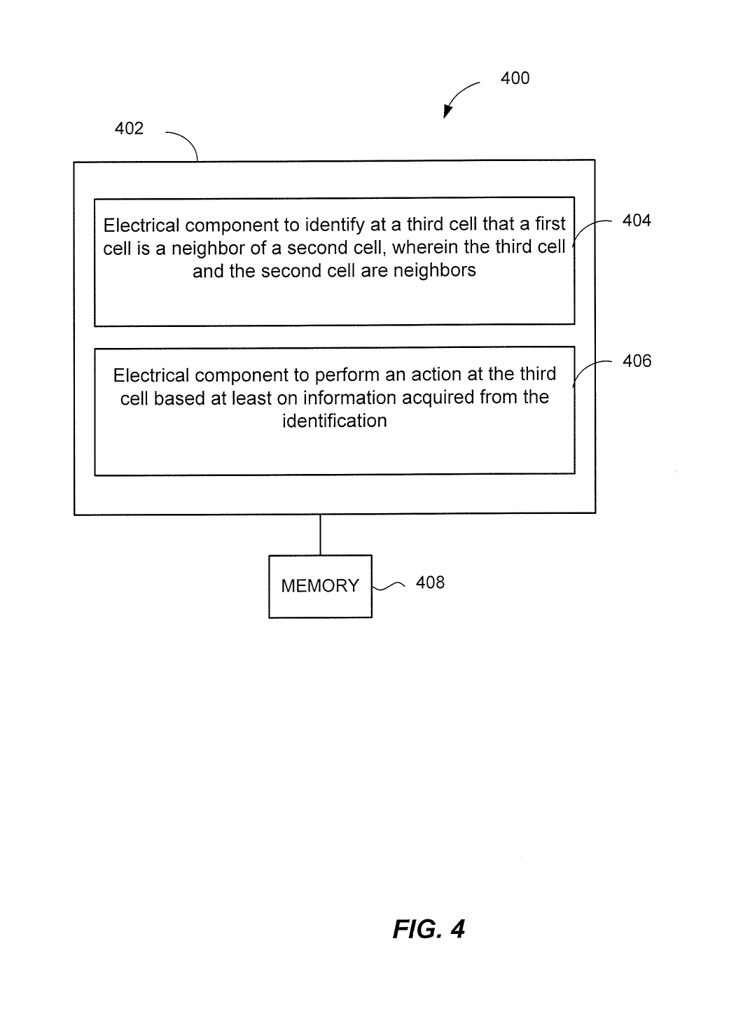

Referring to FIG. 4, an example system 400 is displayed for discovering a cell in a wireless network.

For example, system 400 can reside at least partially within a cell, for example, cells 260 (FIG. 2) and/or cell discovery manager 270 (FIG. 2). It is to be appreciated that system 400 is represented as including functional blocks, which can be functional blocks that represent functions implemented by a processor, software, or combination thereof (for example, firmware). System 400 includes a logical grouping 402 of electrical components that can act in conjunction. For instance, logical grouping 402 may include an electrical component 404 to identify at a third cell that a first cell is a neighbor of a second cell, wherein the third cell and the second cell are neighbors, and wherein the identifying is based at least on a user equipment (UE) history information information element (IE) of a UE. For example, in an aspect, electrical component 404 may comprise cell discovery manager 270 (FIG. 2) and/or cell identifying component 275 (FIG. 2).

Additionally, logical grouping 402 may include an electrical component 406 to performing an action at the third cell based at least on information acquired from the identification. For example, in an aspect, electrical component 406 may comprise cell discovery manager 270 (FIG. 2) and/or action performing component 280 (FIG. 2).

Additionally, system 400 can include a memory 408 that retains instructions for executing functions associated with the electrical components 404 and 406, stores data used or obtained by the electrical components 404 and 406, etc. While shown as being external to memory 408, it is to be understood that one or more of the electrical components 404 and 406 can exist within memory 408. In one example, electrical components 404 and 406 can comprise at least one processor, or each electrical component 404 and 406 can be a corresponding module of at least one processor. Moreover, in an additional or alternative example, electrical components 404 and 406 can be a computer program product including a computer readable medium, where each electrical component 404 and 406 can be corresponding code.

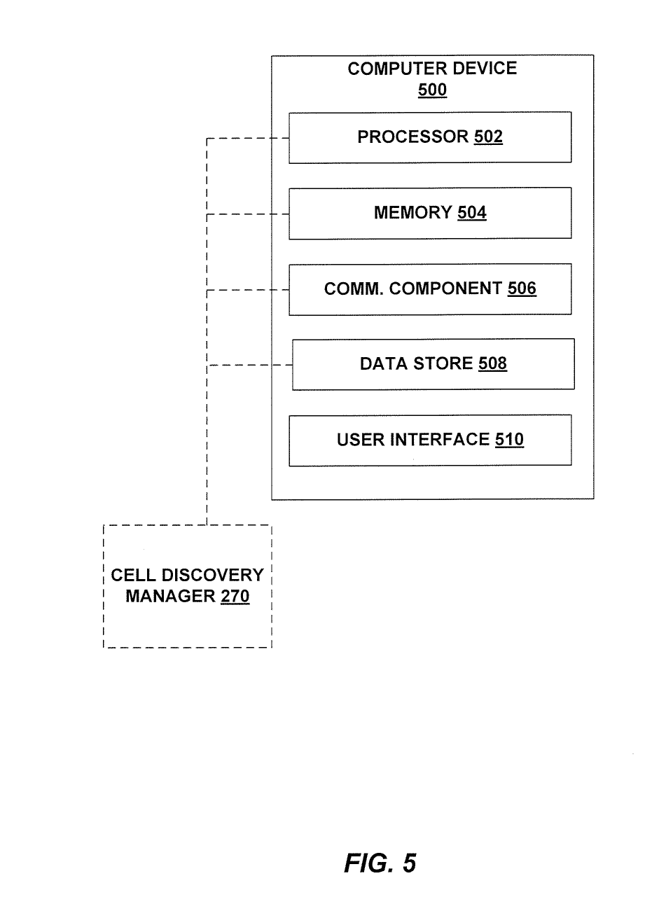

Referring to FIG. 5, in one aspect, any of cells 240, cell_2 250, and/or cell_3 260, including cell discovery manager 270 (FIG. 2) may be represented by a specially programmed or configured computer device 500. In one aspect of implementation, computer device 500 may include cell discovery manager 270, cell identifying component 275, action performing component 280, querying component 285, and/or X2 interface component 290 (FIG. 2), such as in specially programmed computer readable instructions or code, firmware, hardware, or some combination thereof. Computer device 500 includes a processor 502 for carrying out processing functions associated with one or more of components and functions described herein. Processor 502 can include a single or multiple set of processors or multi-core processors. Moreover, processor 502 can be implemented as an integrated processing system and/or a distributed processing system.

Computer device 500 further includes a memory 504, such as for storing data used herein and/or local versions of applications being executed by processor 502. Memory 504 can include any type of memory usable by a computer, such as random access memory (RAM), read only memory (ROM), tapes, magnetic discs, optical discs, volatile memory, non-volatile memory, and any combination thereof.

Further, computer device 500 includes a communications component 506 that provides for establishing and maintaining communications with one or more parties utilizing hardware, software, and services as described herein. Communications component 506 may carry communications between components on computer device 500, as well as between computer device 500 and external devices, such as devices located across a communications network and/or devices serially or locally connected to computer device 500. For example, communications component 506 may include one or more buses, and may further include transmit chain components and receive chain components associated with a transmitter and receiver, respectively, or a transceiver, operable for interfacing with external devices. In an additional aspect, communications component 506 may be configured to receive one or more pages from one or more subscriber networks. In a further aspect, such a page may correspond to the second subscription and may be received via the first technology type communication services.

Additionally, computer device 500 may further include a data store 508, which can be any suitable combination of hardware and/or software, that provides for mass storage of information, databases, and programs employed in connection with aspects described herein. For example, data store 508 may be a data repository for applications not currently being executed by processor 502 and/or any threshold values or finger position values.

Computer device 500 may additionally include a user interface component 510 operable to receive inputs from a user of computer device 500 and further operable to generate outputs for presentation to the user. User interface component 510 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 510 may include one or more output devices, including but not limited to a display, a speaker, a haptic feedback mechanism, a printer, any other mechanism capable of presenting an output to a user, or any combination thereof.

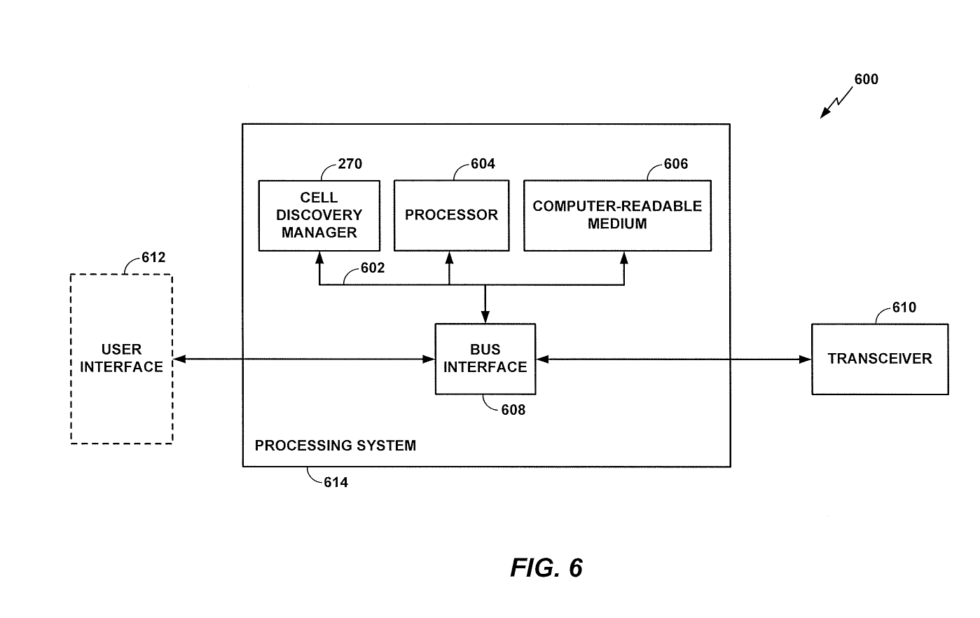

FIG. 6 is a block diagram illustrating an example of a hardware implementation for an apparatus 600, for example, including cell discovery manager 270 of FIG. 2, employing a processing system 614 for carrying out aspects of the present disclosure, such as a method for discovering a cell in a wireless network. In this example, the processing system 614 may be implemented with a bus architecture, represented generally by a bus 602. The bus 602 may include any number of interconnecting buses and bridges depending on the specific application of the processing system 614 and the overall design constraints. The bus 602 links together various circuits including one or more processors, represented generally by the processor 604, computer-readable media, represented generally by the computer-readable medium 606, and one or more components described herein, such as, but not limited to, cell discovery manager 270 (FIG. 2). The bus 602 may also link various other circuits such as timing sources, peripherals, voltage regulators, and power management circuits, which are well known in the art, and therefore, will not be described any further. A bus interface 608 provides an interface between the bus 602 and a transceiver 610. The transceiver 610 provides a means for communicating with various other apparatus over a transmission medium. Depending upon the nature of the apparatus, a user interface 612 (e.g., keypad, display, speaker, microphone, joystick) may also be provided.

The processor 604 is responsible for managing the bus 602 and general processing, including the execution of software stored on the computer-readable medium 606. The software, when executed by the processor 604, causes the processing system 614 to perform the various functions described infra for any particular apparatus. The computer-readable medium 606 may also be used for storing data that is manipulated by the processor 604 when executing software.

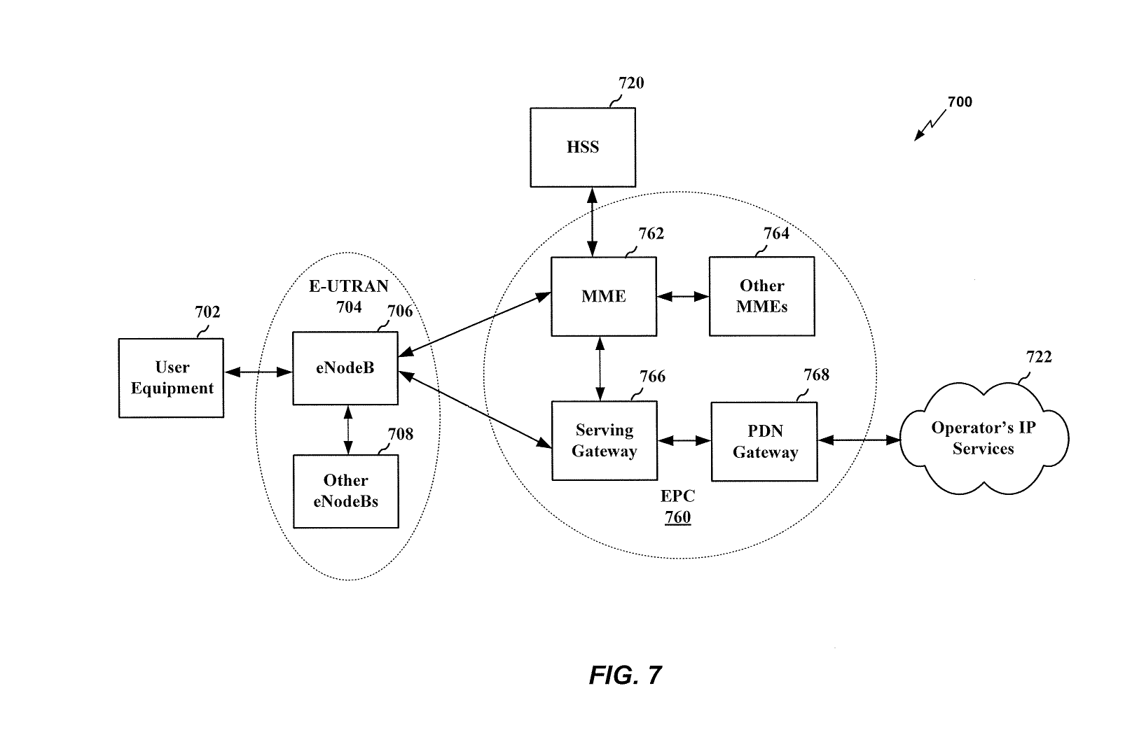

FIG. 7 is a diagram illustrating a long term evolution (LTE) network architecture 700 employing various apparatuses of wireless communication systems of FIGS. 1-2, and may include one or more base stations configured to include a cell discovery manager 270 (FIG. 2). The LTE network architecture 700 may be referred to as an Evolved Packet System (EPS) 700. EPS 700 may include one or more user equipment (UE) 702, an Evolved UMTS Terrestrial Radio Access Network (E-UTRAN) 704, an Evolved Packet Core (EPC) 760, a Home Subscriber Server (HSS) 720, and an Operator's IP Services 722. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved NodeB (eNB) 706 and other eNBs 708. The eNB 706 provides user and control plane protocol terminations toward the UE 702. The eNB 706 may be connected to the other eNBs 708 via an X2 interface (i.e., backhaul). The eNB 706 may also be referred to by those skilled in the art as a base station, a base transceiver station, a radio base station, a radio transceiver, a transceiver function, a basic service set (BSS), an extended service set (ESS), or some other suitable terminology. The eNB 706 provides an access point to the EPC 760 for a UE 702. Examples of UEs 702 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 702 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 706 is connected by an S1 interface to the EPC 760. The EPC 760 includes a Mobility Management Entity (MME) 762, other MMEs 764, a Serving Gateway 766, and a Packet Data Network (PDN) Gateway 768. The MME 762 is the control node that processes the signaling between the UE 702 and the EPC 760. Generally, the MME 762 provides bearer and connection management. All user IP packets are transferred through the Serving Gateway 766, which itself is connected to the PDN Gateway 768. The PDN Gateway 768 provides UE IP address allocation as well as other functions. The PDN Gateway 768 is connected to the Operator's IP Services 722. The Operator's IP Services 722 includes the Internet, the Intranet, an IP Multimedia Subsystem (IMS), and a PS Streaming Service (PSS).

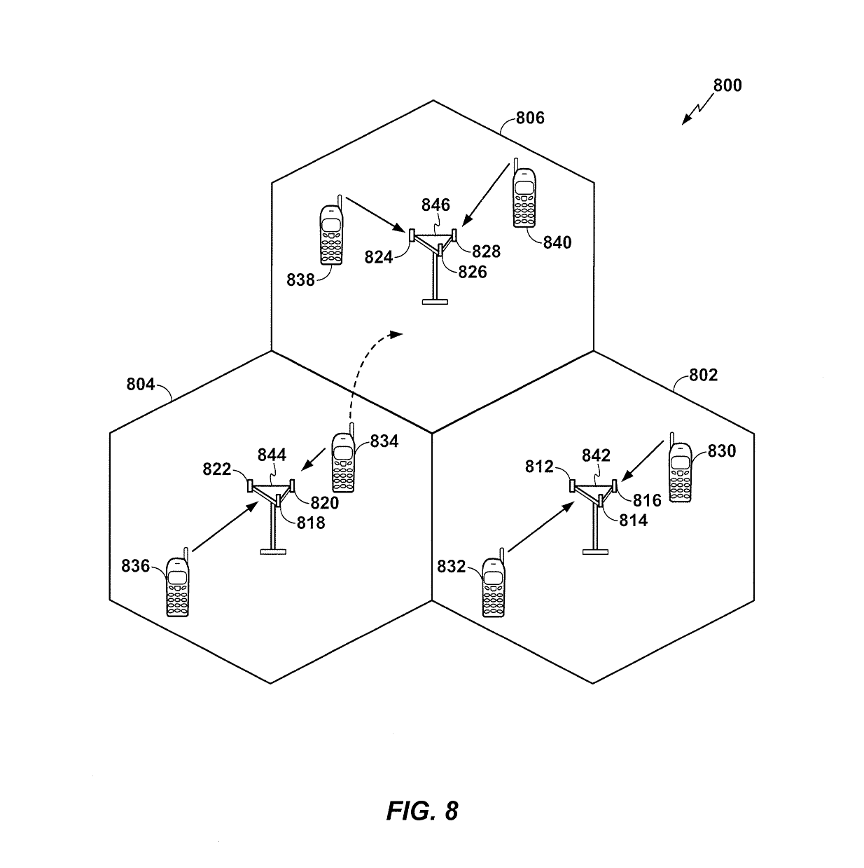

Referring to FIG. 8, an access network 800 in a UTRAN architecture is illustrated, and may include one or more base stations configured to include a cell discovery manager 270 (FIG. 1). The multiple access wireless communication system includes multiple cellular regions (cells), including cells 802, 804, and 806, each of which may include one or more sectors and which may be cells cell_1 240, cell_2 250, and/or cell_3 260 of FIG. 2. The multiple sectors can be formed by groups of antennas with each antenna responsible for communication with UEs in a portion of the cell. For example, in cell 802, antenna groups 812, 814, and 816 may each correspond to a different sector. In cell 804, antenna groups 818, 820, and 822 each correspond to a different sector. In cell 806, antenna groups 824, 826, and 828 each correspond to a different sector. The cells 802, 804 and 806 may include several wireless communication devices, e.g., User Equipment or UEs, for example, including UE 115 of FIG. 2, which may be in communication with one or more sectors of each cell 802, 804, or 806. For example, UEs 830 and 832 may be in communication with NodeB 842, UEs 834 and 836 may be in communication with NodeB 844, and UEs 838 and 840 can be in communication with NodeB 846. Here, each NodeB 842, 844, 846 is configured to provide an access point for all the UEs 830, 832, 834, 836, 838, and 840 in the respective cells 802, 804, and 806. Additionally, each NodeB 842, 844, and 846 may be cell_1 240, cell_2 250, and/or cell_3 260 of FIG. 2 and UEs 830, 832, 834, 836, 838, and 840 may be UE 115 of FIG. 2 and may perform the methods outlined herein.

As the UE 834 moves from the illustrated location in cell 804 into cell 806, a serving cell change (SCC) or handover may occur in which communication with the UE 834 transitions from the cell 804, which may be referred to as the source cell, to cell 806, which may be referred to as the target cell. Management of the handover procedure may take place at the UE 834, at the NodeBs corresponding to the respective cells, at a Mobility Management Entity (MME) 762 (FIG. 7), or at another suitable node in the wireless network. For example, during a call with the source cell 804, or at any other time, the UE 834 may monitor various parameters of the source cell 804 as well as various parameters of neighboring cells such as cells 806 and 802. Further, depending on the quality of these parameters, the UE 834 may maintain communication with one or more of the neighboring cells. During this time, the UE 834 may maintain an Active Set, that is, a list of cells that the UE 834 is simultaneously connected to (i.e., the UTRA cells that are currently assigning a downlink dedicated physical channel DPCH or fractional downlink dedicated physical channel F-DPCH to the UE 834 may constitute the Active Set). In any case, UE 834 may execute reselection manager 104 to perform the reselection operations described herein.

Further, the modulation and multiple access scheme employed by the access network 800 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 902.11 (Wi-Fi), IEEE 902.16 (WiMAX), IEEE 902.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

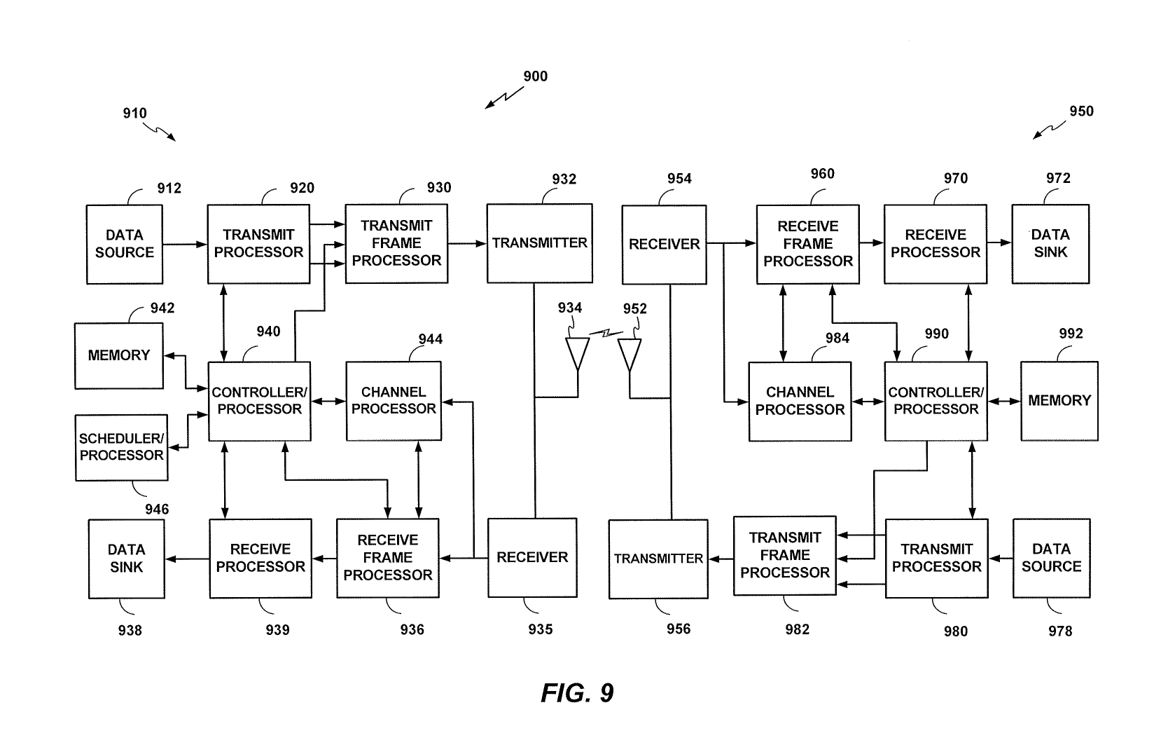

FIG. 9 is a block diagram conceptually illustrating examples of an eNodeB 910 and a UE 950 configured in accordance with an aspect of the present disclosure, wherein the eNodeB may be cell_3 260 of FIG. 2 that is configured to include cell discovery manager 270. For example, the base station/eNodeB 910 and the UE 950 of system 900, as shown in FIG. 9, may be one of base stations/eNodeBs and one of the UEs in FIGS. 1-2.

In the downlink communication, a transmit processor 920 may receive data from a data source 912 and control signals from a controller/processor 940. The transmit processor 920 provides various signal processing functions for the data and control signals, as well as reference signals (e.g., pilot signals). For example, the transmit processor 920 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 944 may be used by a controller/processor 940 to determine the coding, modulation, spreading, and/or scrambling schemes for the transmit processor 920. These channel estimates may be derived from a reference signal transmitted by the UE 950 or from feedback from the UE 950. The symbols generated by the transmit processor 920 are provided to a transmit frame processor 930 to create a frame structure. The transmit frame processor 930 creates this frame structure by multiplexing the symbols with information from the controller/processor 940, resulting in a series of frames. The frames are then provided to a transmitter 932, which provides various signal conditioning functions including amplifying, filtering, and modulating the frames onto a carrier for downlink transmission over the wireless medium through antenna 934. The antenna 934 may include one or more antennas, for example, including beam steering bidirectional adaptive antenna arrays or other similar beam technologies.

At the UE 950, a receiver 954 receives the downlink transmission through an antenna 952 and processes the transmission to recover the information modulated onto the carrier. The information recovered by the receiver 954 is provided to a receive frame processor 960, which parses each frame, and provides information from the frames to a channel processor 984 and the data, control, and reference signals to a receive processor 970. The receive processor 970 then performs the inverse of the processing performed by the transmit processor 920 in the NodeB 910. More specifically, the receive processor 970 descrambles and despreads the symbols, and then determines the most likely signal constellation points transmitted by the NodeB 910 based on the modulation scheme. These soft decisions may be based on channel estimates computed by the channel processor 984. The soft decisions are then decoded and deinterleaved to recover the data, control, and reference signals. The CRC codes are then checked to determine whether the frames were successfully decoded. The data carried by the successfully decoded frames will then be provided to a data sink 972, which represents applications running in the UE 950 and/or various user interfaces (e.g., display). Control signals carried by successfully decoded frames will be provided to a controller/processor 990. When frames are unsuccessfully decoded by the receive processor 970, the controller/processor 990 may also use an acknowledgement (ACK) and/or negative acknowledgement (NACK) protocol to support retransmission requests for those frames.

In the uplink, data from a data source 978 and control signals from the controller/processor 990 are provided to a transmit processor 980. The data source 978 may represent applications running in the UE 950 and various user interfaces (e.g., keyboard). Similar to the functionality described in connection with the downlink transmission by the NodeB 910, the transmit processor 980 provides various signal processing functions including CRC codes, coding and interleaving to facilitate FEC, mapping to signal constellations, spreading with OVSFs, and scrambling to produce a series of symbols. Channel estimates, derived by the channel processor 984 from a reference signal transmitted by the NodeB 910 or from feedback contained in the midamble transmitted by the NodeB 910, may be used to select the appropriate coding, modulation, spreading, and/or scrambling schemes. The symbols produced by the transmit processor 980 will be provided to a transmit frame processor 982 to create a frame structure. The transmit frame processor 982 creates this frame structure by multiplexing the symbols with information from the controller/processor 990, resulting in a series of frames. The frames are then provided to a transmitter 956, which provides various signal conditioning functions including amplification, filtering, and modulating the frames onto a carrier for uplink transmission over the wireless medium through the antenna 952.

The uplink transmission is processed at the NodeB 910 in a manner similar to that described in connection with the receiver function at the UE 950. A receiver 935 receives the uplink transmission through the antenna 934 and processes the transmission to recover the information modulated onto the carrier. The information recovered by the receiver 935 is provided to a receive frame processor 936, which parses each frame, and provides information from the frames to the channel processor 944 and the data, control, and reference signals to a receive processor 939. The receive processor 939 performs the inverse of the processing performed by the transmit processor 980 in the UE 950. The data and control signals carried by the successfully decoded frames may then be provided to a data sink 938 and the controller/processor, respectively. If some of the frames were unsuccessfully decoded by the receive processor, the controller/processor 940 may also use an acknowledgement (ACK) and/or negative acknowledgement (NACK) protocol to support retransmission requests for those frames.

The controller/processors 940 and 990 may be used to direct the operation at the NodeB 910 and the UE 950, respectively. For example, the controller/processors 940 and 990 may provide various functions including timing, peripheral interfaces, voltage regulation, power management, and other control functions. The computer readable media of memories 942 and 992 may store data and software for the NodeB 910 and the UE 950, respectively. A scheduler/processor 946 at the NodeB 910 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer.

The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for discovering a cell in a wireless network, comprising:
identifying at a third cell that a first cell is a neighbor of a second cell, wherein the third cell and the second cell are neighbors, and wherein the identifying is based at least on a user equipment (UE) history information information element (IE) of a UE; and
performing an action at the third cell based at least on information acquired from the identification.

2. The method of claim 1, wherein performing the action includes changing a physical cell identity (PCI), a frequency, a transmitted (TX) power, or any combination thereof, of the third cell.

3. The method of claim 1, wherein performing the action includes establishing an X2 interface between the third cell and the first cell.

4. The method of claim 3, further comprising:
querying a PCI, a frequency, a TX power, or any combination thereof, of the first cell.

5. The method of claim 1, wherein performing the action comprises:
querying a network entity for the information of the first cell, wherein the querying includes sending of a cell identifier or evolved universal terrestrial access network (E-UTRAN) cell global identifier (eCGI) of the first cell to the network entity.

6. The method of claim 5, further comprising:
querying a PCI, a frequency, a transmitted (TX) power, or any combination thereof, of the first cell from the network entity.

7. The method of claim 1, wherein performing the action includes changing a physical cell identity (PCI), a frequency, a transmitted (TX) power, or any combination thereof, of the third cell based at least on the information in the UE history information IE.

8. The method of claim 1, wherein the UE history information IE comprises information at least about past serving cells of the UE.

9. The method of claim 1, wherein the third cell communicates with the second cell via a S1 interface.

10. The method of claim 1, wherein a X2 interface is absent between the second cell and the third cell.

11. An apparatus for discovering a cell in a wireless network, comprising:
means for identifying at a third cell that a first cell is a neighbor of a second cell, wherein the third cell and the second cell are neighbors, and wherein the identifying is based at least on a user equipment (UE) history information information element (IE) of a UE; and
means for performing an action at the third cell based at least on information acquired from the identification.

12. The apparatus of claim 11, wherein the means for performing the action includes changing a physical cell identity (PCI), a frequency, a transmitted (TX) power, or any combination thereof, of the third cell.

13. The apparatus of claim 11, wherein the means for performing the action includes establishing an X2 interface between the third cell and the first cell.

14. The apparatus of claim 11, wherein means for performing the action comprises:
means for querying a network entity for the information of the first cell, wherein the querying includes sending of a cell identifier or evolved universal terrestrial access network (E-UTRAN) cell global identifier (eCGI) of the first cell to the network entity.

15. The apparatus of claim 11, wherein the UE history information IE comprises information at least about past serving cells of the UE.

16. A computer readable medium storing computer executable code for discovering a cell in a wireless network, comprising:
code for identifying at a third cell that a first cell is a neighbor of a second cell, wherein the third cell and the second cell are neighbors, and wherein the identifying is based at least on a user equipment (UE) history information information element (IE) of a UE; and
code for performing an action at the third cell based at least on information acquired from the identification.

17. The computer readable medium of claim 16, wherein the code for performing the action includes code for changing a physical cell identity (PCI), a frequency, a transmitted (TX) power, or any combination thereof, of the third cell.

18. The computer readable medium of claim 16, wherein the code for performing the action includes code for establishing an X2 interface between the third cell and the first cell.

19. The computer readable medium of claim 16, wherein the code for performing the action includes:
code for querying a network entity for the information of the first cell, wherein the querying includes sending of a cell identifier or evolved universal terrestrial access network (E-UTRAN) cell global identifier (eCGI) of the first cell to the network entity.

20. The computer readable medium of claim 16, wherein the UE history information IE comprises information at least about past serving cells of the UE.

21. An apparatus for discovering a cell in a wireless network, comprising:
a processor and a memory, the processor and the memory configured to:
identify at a third cell that a first cell is a neighbor of a second cell, wherein the third cell and the second cell are neighbors, and wherein the identifying is based at least on a user equipment (UE) history information information element (IE) of a UE; and
perform an action at the third cell based at least on information acquired from the identification.

22. The apparatus of claim 21, wherein the processor is further configured to change a physical cell identity (PCI), a frequency, a transmitted (TX) power, or any combination thereof, of the third cell.

23. The apparatus of claim 21, wherein the processor is further configured to establish an X2 interface between the third cell and the first cell.

24. The apparatus of claim 23, wherein the processor is further configured to query a PCI, a frequency, a TX power, or any combination thereof, of the first cell.

25. The apparatus of claim 21, wherein the processor is further configured to query a network entity for the information of the first cell, wherein the querying includes sending of a cell identifier or evolved universal terrestrial access network (E-UTRAN) cell global identifier (eCGI) of the first cell to the network entity.

26. The apparatus of claim 25, wherein the processor is further configured to query a PCI, a frequency, a transmitted (TX) power, or any combination thereof, of the first cell from the network entity.

27. The apparatus of claim 21, wherein the processor is further configured to change a physical cell identity (PCI), a frequency, a transmitted (TX) power, or any combination thereof, of the third cell based at least on the information in the UE history information IE.

28. The apparatus of claim 21, wherein the UE history information IE comprises information at least about past serving cells of the UE.

29. The apparatus of claim 21, wherein the third cell communicates with the second cell via a S1 interface.

30. The apparatus of claim 21, wherein a X2 interface is absent between the second cell and the third cell.
